(19) United States
(12) Patent Application Publication
(10) Pub. No.: US 2012/0312991 A1
(43) Pub. Date: Dec. 13, 2012

(54) Direction Interpreting Device

(76) Inventor: WEN-I HUANG, Luzhu Township (TW)

(21) Appl. No.: 13/154,461

(22) Filed: Jun. 7, 2011

(51) Int. Cl. G01J 5/10

(52) U.S. Cl. 250/349

(57) ABSTRACT

A direction interpreting device comprises a sensor and a plate. The sensor includes a positive sensor unit for generating a positive sensor signal and a negative sensor unit for generating a negative sensor signal. The plate is disposed between the positive sensor unit and the negative sensor unit or disposed outside of the sensor. The plate extends beyond the sensor to block the positive sensor signal generated by the positive sensor unit and the negative sensor signal generated by the negative sensor unit. The sensor can interpret a moving direction of an object via a time difference between a responsive waveform of the positive sensor unit and a responsive waveform of the negative sensor unit.

### (a) TECHNICAL FIELD OF THE INVENTION

The present invention relates to a direction interpreting device and, more particularly, to a direction interpreting device having a plate disposed between a positive sensor unit and a negative sensor unit thereof to block the sensor signals.

### (b) DESCRIPTION OF THE PRIOR ART

Conventionally, for counting the persons in a site, two proximity sensors, such as infrared sensors, are respectively mounted on an entry and an exit of the site. The infrared sensor can be activated at the moment of a person moving to a location within its detecting scope. Thus, when a person moves to the entry point for entering the site, the counting number will increase by one; when a person moves to the exit point for leaving the site, the counting number will decrease by one. However, this method cannot be applied in a site in which the access point is bidirectional, as the conventional proximity sensors cannot interpret the moving direction of an object. Thus, there is a need to improve the conventional proximity sensors to enable them to detect the moving direction of a person so as to conduct a count more accurately.

### SUMMARY OF THE INVENTION

The primary object of the present invention is to provide a direction interpreting device, in which a plate is disposed in a sensor and extends beyond the sensor, or disposed outside of a sensor, to block the signals respectively generated by a positive sensor unit and a negative sensor unit of the sensor.

Another object of the present invention is to provide a direction interpreting device, in which a focusing lens is disposed at a predetermined distance from the sensor to increase the detecting scope of the sensor.

According to one aspect of the present invention, the direction interpreting device comprises a sensor and a plate, wherein the sensor includes a positive sensor unit for generating a positive sensor signal and a negative sensor unit for generating a negative sensor signal, the plate is disposed between the positive sensor unit and the negative sensor unit or disposed outside of the sensor, the plate extending beyond the sensor to block the positive sensor signal generated by the positive sensor unit and the negative sensor signal generated by the negative sensor unit; whereby the sensor can interpret a moving direction of an object via a time difference between a responsive waveform of the positive sensor unit and a responsive waveform of the negative sensor unit.

Other objects, advantages, and novel features of the present invention will become more apparent from the following detailed description when taken in conjunction with the accompanying drawings.

### BRIEF DESCRIPTION OF THE DRAWINGS

FIG. 1 schematically shows a first embodiment of the present invention.

FIG. 2 schematically shows the first embodiment of the present invention and illustrates an operation thereof.

FIG. 3 schematically shows a wave diagram of the sensor signal of the sensor in the present invention.

FIG. 4 schematically shows a second embodiment of the present invention.

FIG. 5 schematically shows a third embodiment of the present invention.

FIG. 6 schematically shows a fourth embodiment of the present invention.

FIG. 7 schematically shows a fifth embodiment of the present invention and illustrates an operation thereof.

### DETAILED DESCRIPTION OF THE PREFERRED EMBODIMENTS

To allow the features, advantages, and effects of the present invention to be more easily understood, the present invention will be described in detail with reference to the accompanying drawings in the following paragraphs.

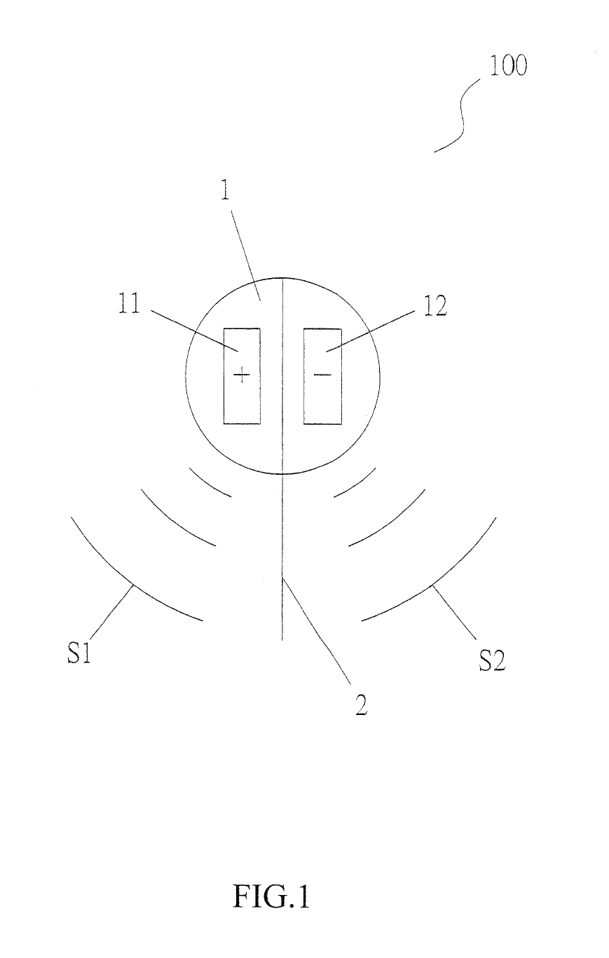

FIG. 1 schematically shows a first embodiment of the present invention. As shown, the direction interpreting device 100 comprises a sensor 1 and a plate 2. The sensor 1 is a passive infrared sensor, which includes a positive sensor unit 11 and a negative sensor unit 12. The positive sensor unit 11 is used for generating a positive sensor signal S1. The negative sensor unit 12 is used for generating a negative sensor signal S2. The sensor 1 can detect the status of a person via the positive sensor signal S1 and the negative sensor signal S2. Since the construction and principles of passive infrared sensors are of prior art and they are not key points of the present invention, a description for them is eliminated here.

The plate 2 is disposed between the positive sensor unit 11 and the negative sensor unit 12. The plate 2, being made of far-infrared light resistant material, extends out of the sensor 1 to block the positive sensor signal S1 and the negative sensor signal S2 to prevent an overlap of the positive sensor signal S1 and the negative sensor signal S2.

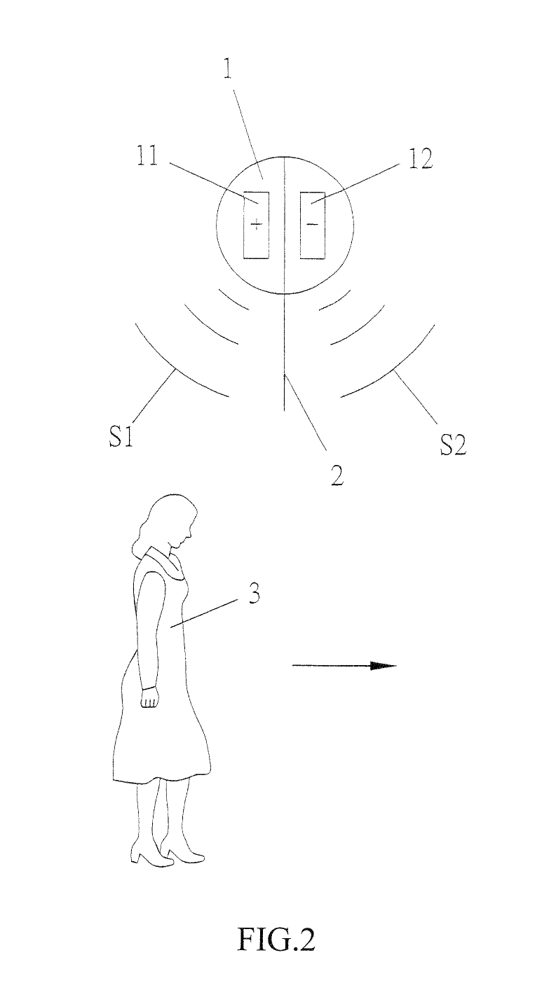

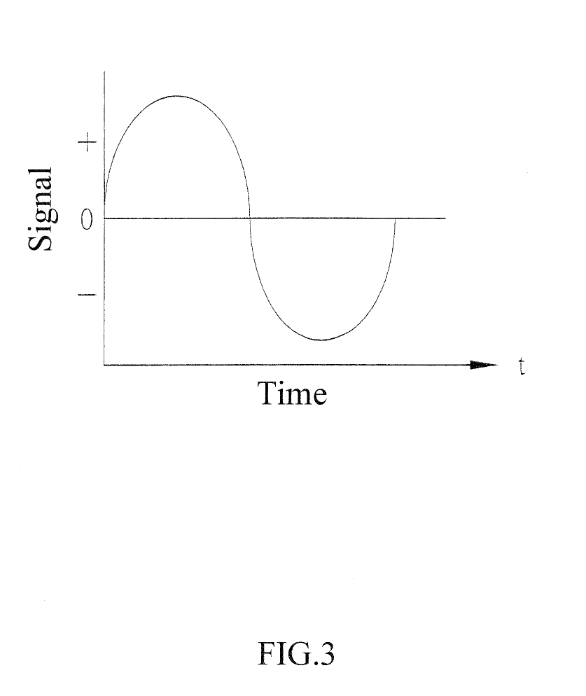

FIG. 2 schematically illustrates the operation of the first embodiment of the present invention. FIG. 3 shows a wave diagram of the sensor signal of the sensor. In implementing the present invention, the direction interpreting device will be placed at a predetermined location to allow the sensor 1 to detect a movement of a person 3 via the positive sensor signal S1 generated by the positive sensor unit 11 and the negative sensor signal S2 generated by the negative signal unit 12. The plate 2 is used for blocking the positive sensor signal S1 and the negative sensor signal S2.

When the person 3 enters the detecting scope of the positive sensor signal S1 generated by the positive sensor unit 11, the positive sensor unit 11 can generate a responsive waveform, the intensity of which depends on the intensity of the positive sensor signal S1 and the movement of the person 3.

When the person 3 leaves the detecting scope of the positive sensor signal S1 to enter the detecting scope of the negative sensor signal S2 generated by the negative sensor unit 12, the negative sensor unit 12 can generate a responsive waveform, the intensity of which depends on the intensity of the negative sensor signal S2 and the movement of the person 3. When the person 3 leaves the scope of the sensor 1, the responsive waveform will return to zero level. Thus, according to the time difference between the responsive waveforms of the positive sensor unit 11 and the negative sensor unit 12, the sensor 1 can interpret the moving direction of the person 3.

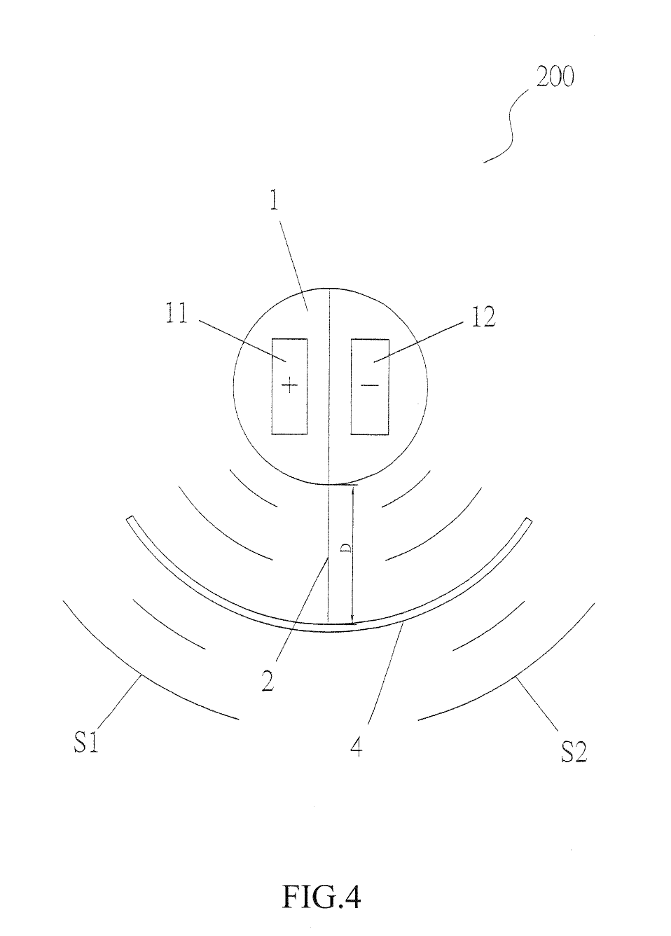

FIG. 4 schematically shows a second embodiment of the present invention. As shown, this embodiment has components approximately the same as the first embodiment and thus has the same numeral for each corresponding component. The difference of the two embodiments is that the second embodiment is further provided with a focusing lens 4 disposed at a predetermined distance from the sensor 1 for increasing the detecting scope of the sensor 1. Since the construction and principles of this embodiment are the same as those of the first embodiment, a description for them is eliminated here.

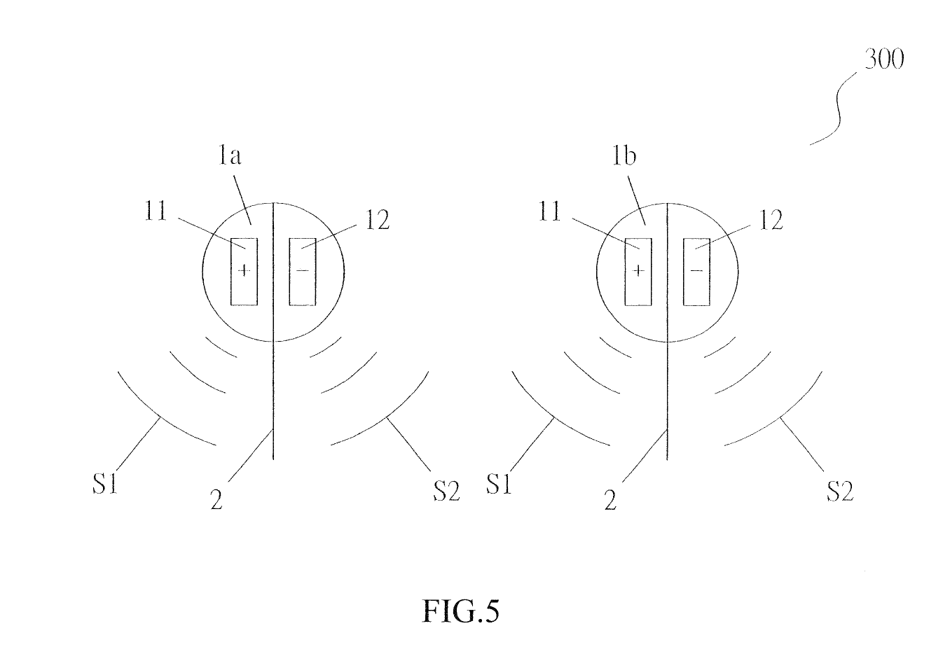

FIG. 5 schematically shows a third embodiment of the present invention. As shown, this embodiment has components approximately the same as the first embodiment and thus has the same numeral for each corresponding component. The difference of the two embodiments is that the third embodiment includes two sensors 1a, 1b for increasing the detecting scope. Since the construction and principles of this embodiment are the same as those of the first embodiment, a description for them is eliminated here.

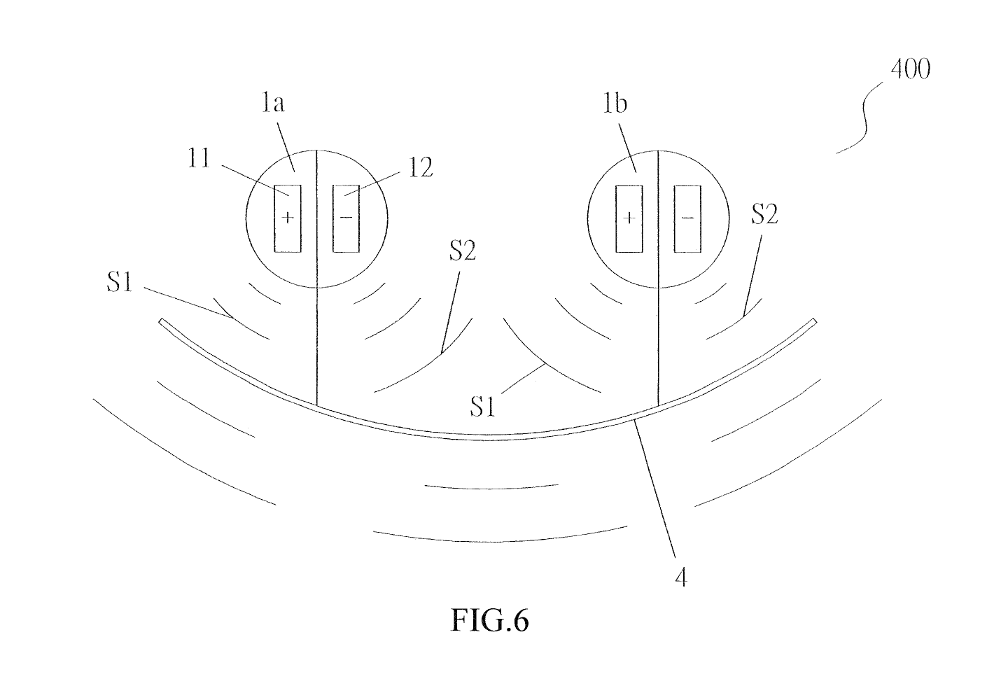

FIG. 6 schematically shows a fourth embodiment of the present invention. As shown, this embodiment has components approximately the same as the third embodiment and thus has the same numeral for each corresponding component. The difference of the two embodiments is that this embodiment further includes a focusing lens 4 disposed outside of the two sensors 1a, 1b for increasing the detecting scopes of the sensors 1a, 1b. Since the construction and principles of this embodiment are the same as those of the first embodiment, a description for them is eliminated here.

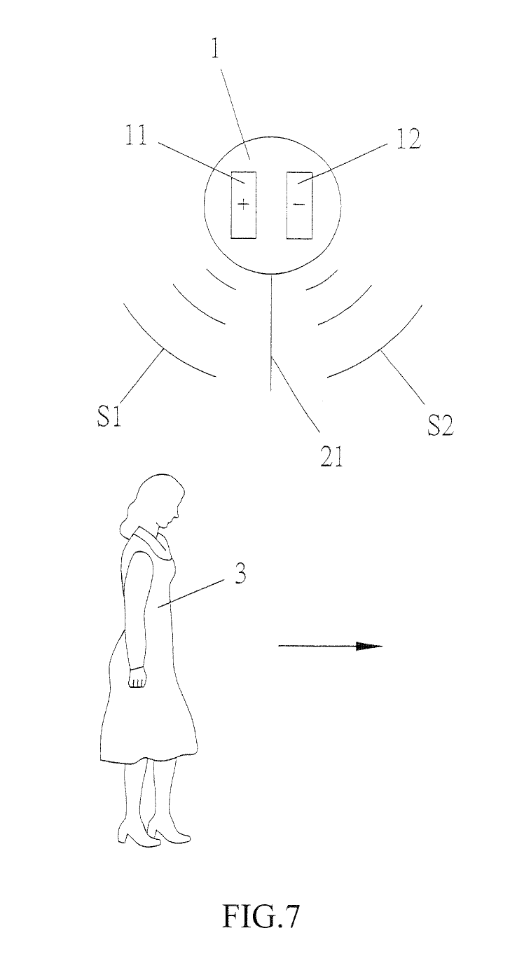

FIG. 7 schematically shows a fifth embodiment of the present invention. In implementing the embodiment, the direction interpreting device will be placed at a predetermined location to allow the sensor 1 to detect the movement of the person 3 via the positive sensor signal S1 generated by the positive sensor unit 11 and the negative sensor signal S2 generated by the negative signal unit 12. The plate 21 is disposed outside of the sensor 1 to block the positive sensor signal S1 and the negative sensor signal S2. When the person 3 leaves the detecting scope of the positive sensor signal S1 to enter the detecting scope of the negative sensor signal S2, the negative sensor unit 12 can generate a responsive waveform, the intensity of which depends on the intensity of the negative sensor signal S2 and the movement of the person 3. When the person 3 leaves the detecting scope of the sensor 1, the responsive waveform will return to zero level. Thus, according to the time difference between the responsive waveforms of the positive sensor unit 11 and the negative sensor unit 12, the sensor 1 can interpret the moving direction of the person 3.

In view of the foregoing, the present invention employs a sensor that can detect the moving direction of a person and a plate that can prevent overlap of the sensor signals to achieve the purpose of interpreting the moving direction of the person. Therefore, the present invention can obtain a more accurate result in counting persons in a site than conventional devices.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A direction interpreting device, comprising:
at least one sensor including a positive sensor unit for generating a positive sensor signal and a negative sensor unit for generating a negative sensor signal; and
at least one plate disposed between said positive sensor unit and said negative sensor unit, said plate extending beyond said sensor to block the positive sensor signal generated by said positive sensor unit and the negative sensor signal generated by said negative sensor unit; whereby said sensor can interpret a moving direction of an object via a time difference between a responsive waveform of said positive sensor unit and a responsive waveform of said negative sensor unit.

2. The direction interpreting device of claim 1, further comprising a focusing lens disposed at a predetermined distance from said sensor.

3. The direction interpreting device of claim 2, wherein said sensor is a passive infrared sensor.

4. The direction interpreting device of claim 3, wherein said plate is made of far-infrared light resistant material.

5. A direction interpreting device, comprising:
at least one sensor including a positive sensor unit for generating a positive sensor signal and a negative sensor unit for generating a negative sensor signal; and
at least one plate disposed outside of said sensor to block the positive sensor signal generated by said positive sensor unit and the negative sensor signal generated by said negative sensor unit; whereby said sensor can interpret a moving direction of an object via a time difference between a responsive waveform of said positive sensor unit and a responsive waveform of said negative sensor unit.

6. The direction interpreting device of claim 5, further comprising a focusing lens disposed at a predetermined distance from said sensor.

7. The direction interpreting device of claim 6, wherein said sensor is a passive infrared sensor.

8. The direction interpreting device of claim 7, wherein said plate is made of far-infrared light resistant material.
